(19) United States
(12) Patent Application Publication
(10) Pub. No.: US 2014/0043837 A1
(43) Pub. Date: Feb. 13, 2014

(54) LIGHTING SYSTEM FOR USE WITH THERMALLY-INSULATED RECEPTACLES

(71) Applicant: David Michaud, Chichester, NH (US)

(72) Inventor: David Michaud, Chichester, NH (US)

(21) Appl. No.: 13/572,821

(22) Filed: Aug. 13, 2012

(51) Int. Cl. F25D 27/00; B63B 45/00; F21S 8/10

(52) U.S. Cl. CPC F25D 27/00; F21S 48/328; B63B 45/00
USPC 362/477; 362/92; 362/547

(57) ABSTRACT

The lighting system for use with thermally-insulated receptacles comprises a replaceable lid, a light source, and a power source. The lighting system further comprises an additional layer of material covering the light source and power source to limit exposure to moisture and to limit contact with the items stored within the thermally-insulated receptacle. The lighting system for use with thermally-insulated receptacles is configured to be used as safety equipment to signal others when the user is in distress. The lighting system for use with thermally-insulated receptacles is configured to be used with stand-alone, thermally-insulated receptacles or with thermally-insulated receptacles integrally formed in or on land vehicle or water craft.

### FIELD OF THE INVENTION

The present invention relates to illuminated, thermally-insulated containers and more particularly to removable lighting systems for use in illuminating a variety of thermally-insulated receptacles.

### BACKGROUND OF THE INVENTION

Thermally-insulated containers come in many different sizes and shapes. These containers are sometimes referred to as coolers or ice boxes and may be portable, stand-alone containers, or may be integrally formed within vehicles and the like. Some integrally formed thermally-insulated containers may be found in campers, cars, vans, trucks, motorcycles, scooters, sailboats, powerboats, jet skis, kayaks, and the like.

Thermally-insulated containers are often used in situations where access to electricity is limited in some way. These situations may include while traveling or even in times of unexpected power outages such as during or following a natural disaster or storm. In such situations, the use of a thermally-insulated container can be difficult in low light areas and make the quick selection of particular contents stored within the container very difficult. Often, in situations where access to electricity is limited in some way the access to cooling is also limited and the need to have the thermally-insulated container open for a brief time is critical to preserving the contents at appropriate temperatures to avoid spoilage.

The present invention provides a replaceable lid for a variety of thermally-insulated containers and thus is an inexpensive upgrade to existing thermally-insulated containers and provides a self-contained lighting system for use with the thermally-insulated containers. The present invention also provides a replaceable lid, or lighting system, which can be used to illuminate an area external to the thermally-insulated container. Furthermore, the present invention can be used as safety equipment to alert others that the user is in distress.

### SUMMARY OF THE INVENTION

One aspect of the present invention is a lighting system for use with a thermally-insulated container, comprising: a light source, wherein the light source comprises at least one LED; a power source, wherein the power source comprises at least one battery and is in electrical connection with the light source; and a replaceable lid, wherein the lid is formed to fit onto a thermally-insulated container and is configured to accept the light source and the power source.

One embodiment of the lighting system for use with a thermally-insulated container is wherein the lid further comprises a layer configured to cover the light source and power source thereby preventing exposure of the light source and power source to moisture.

One embodiment of the lighting system for use with a thermally-insulated container is wherein the layer is colored. One embodiment of the lighting system for use with a thermally-insulated container is wherein the layer is transparent.

One embodiment of the lighting system for use with a thermally-insulated container is wherein the at least one LED is colored. One embodiment of the lighting system for use with a thermally-insulated container is wherein the at least one LED is configured to produce in light.

One embodiment of the lighting system for use with a thermally-insulated container is wherein the light source is used to signal for help.

One embodiment of the lighting system for use with a thermally-insulated container is wherein the at least one LED comprises a strip of LEDs.

One embodiment of the lighting system for use with a thermally-insulated container is wherein the at least one battery is rechargeable.

One embodiment of the lighting system for use with a thermally-insulated container further comprises at least one solar cell for recharging the at least one battery.

One embodiment of the lighting system for use with a thermally-insulated container is wherein the light source and power source are reversibly attached to the lid and are capable of acting as a stand-alone light.

One embodiment of the lighting system for use with a thermally-insulated container is wherein the thermally-insulated container is integrally formed in a land vehicle.

One embodiment of the lighting system for use with a thermally-insulated container is wherein the thermally-insulated container is integrally-formed in a water craft.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1A and FIG. 1B represent perspective views of embodiments of the lighting system of the present invention.

FIG. 2 represents an exploded view of an embodiment of the lighting system of the present invention.

FIG. 3 represents a top view of an embodiment of the lighting system of the present invention.

### DETAILED DESCRIPTION OF THE INVENTION

The lighting system of the present invention provides replaceable lids for a variety of thermally-insulated storage containers, including portable coolers of various sizes, insulated compartments for use on or in motorcycles, cars, vans, campers, or other land vehicles, as well as on or in water craft, such as sailboats, power boats, jet skis, kayaks, and the like. The replaceable lids can be made separately to fit existing thermally-insulated storage containers, or can by incorporated into a new thermally-insulted storage containers at the time of manufacture.

Replaceable lids may contain removable lights for use separately as flashlights, head lamps, and the like and can be reversibly attached to the inside of the lid or on the inner walls of the insulated storage containers. There are several mechanisms for reversibly attaching the lights which are known to those skilled in the art. These mechanisms include, but are not limited to, Velcro, magnets, adhesives, or other mechanical attachments.

In another embodiment, the replacement lids can include an additional layer of material to help reduce moisture exposure to the components of lighting system, or light source and power source, of the lid, and also minimize or eliminate contact between the contents stored inside the insulted storage container and the components of the lighting system. The additional layer can be clear, transparent, translucent, colored, semi-transparent, and the like to provide a variety of properties.

In another embodiment, the components of the lighting system can be sold as a kit comprising removable lighting systems for use in or on existing thermally-insulated storage containers. The lighting system kit comprises a power source, a light source, and a mechanism for reversibly attaching the lighting system to the thermally-insulated storage container. The lighting system kit of the present invention further comprises an additional layer of material to help reduce moisture exposure and also minimize or eliminate contact between the contents stored inside the insulted storage container and the components of the lighting system. The additional layer of material can be clear, transparent, translucent, colored, semi-transparent, and the like to provide a variety of properties.

The lighting source of the present invention can be manually turned on/off, or can be regulated using methods well known to those of skill in the art in response to opening and/or removing the replaceable lid, or cover, of the thermally-insulated storage container.

Various power sources are known to those of skill in the art and are applicable to the present invention. Power sources may include primary batteries (disposable batteries), which are designed to be used once and discarded, and secondary batteries (rechargeable batteries), which are designed to be recharged and used multiple times. The rechargeable batteries may be recharged using conventional methods, solar cells, and the like. Various light sources are also know to those of ordinary skill in the art and are applicable to the present invention. In one embodiment, the light source is an LED. LEDs come in a variety of colors, and forms. LEDs can be in strips, in clusters, or can consist of a single LED. The lighting system of the present invention may also include multimode light sources that contain multiple colors or settings, including modulated light including, but not limited to, strobes, flashes, pulses, and the like. The light sources may also function as safety equipment if the user is in distress. In one embodiment, the LED is low power and high brightness and may be spotted at great distances. In one embodiment, the LEDs can be multi-colored. In one embodiment, the LED produces modulated light configured to signal “S-O-S” to alert others.

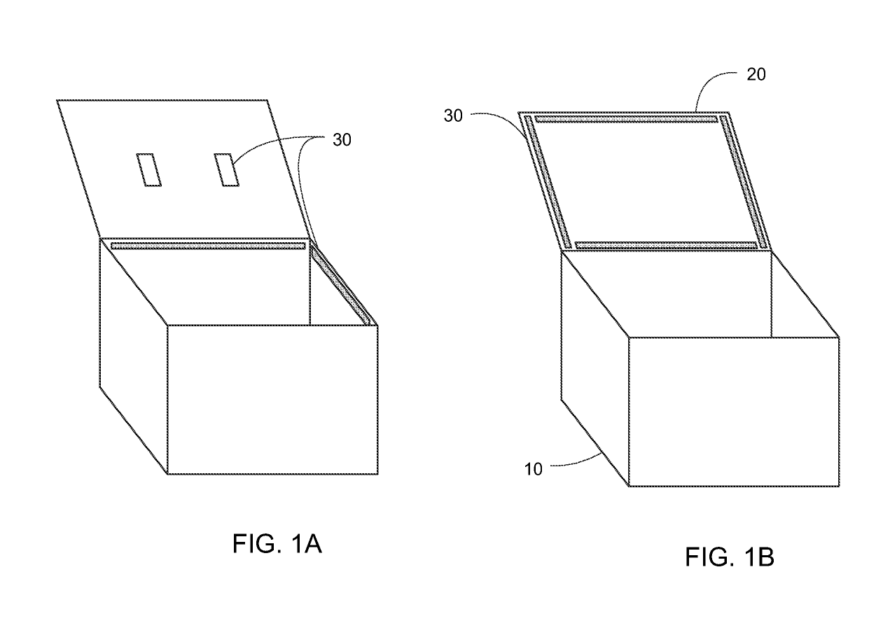

FIG. 1A and FIG. 1B represent perspective views of embodiments of the lighting system of the present invention. More specifically, FIG. 1A shows one embodiment of the present invention as seen on a stand-alone, thermally-insulated storage container 10. It is understood that there are numerous shapes and sizes of thermally-insulted storage containers and as such numerous sizes and shapes of replaceable lids, or covers. There are also numerous methods to mount replaceable lids and covers known to those of skill in the art based on the mechanism for opening and closing the lid or cover which include, but are not limited to, sliding, hinging, seating in a groove inside the body of the thermally-insulated storage container, and the like.

In FIGS. 1A and 1B the replaceable lid, or cover 20, is shown as hinged. Various forms of light sources are shown 30. In certain embodiments, the light sources are strip LEDs and others are multimode LEDs. In certain embodiments of the present invention, the light sources can be removable and function separately as flashlights or as safety equipment. Alternatively, the replaceable lid can be removed from the thermally-insulated storage container and be used to signal distress or to generally light an area.

As seen in FIG. 1A, in certain embodiments the light source may also be movable to other locations within the body of the storage container, if desired. In some embodiments of the present invention, the power sources can be incorporated in a light source unit, or can be electrically connected and embedded in the replaceable lid. In certain embodiments, the replaceable lid may be hollow or solid and may have areas where the power source and/or light source are set into the cover or lid in certain embodiments. The replaceable lids may be made out of materials including, but not limited to polymers, foam, plastic, wood, metal, combinations thereof, and the like.

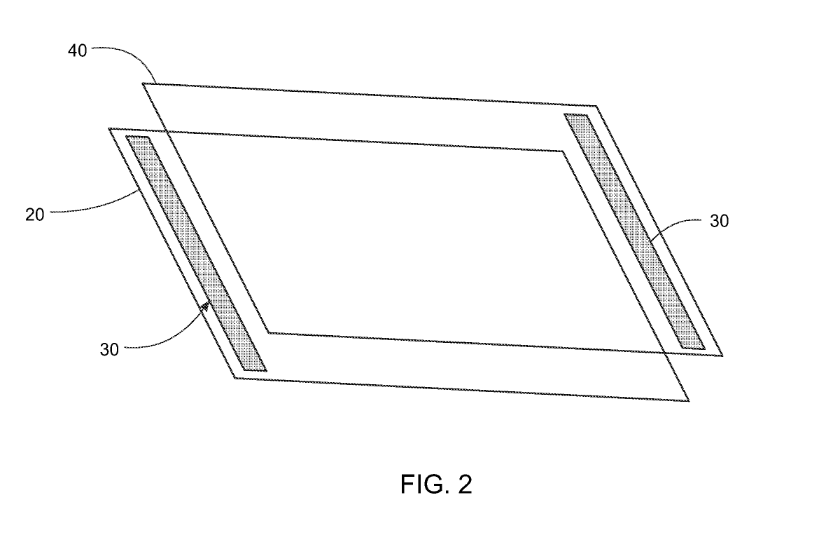

FIG. 2 represents an exploded view of an embodiment of the lighting system of the present invention. More specifically, the replaceable lid 20 comprises multiple light sources 30 located under a layer of additional material 40. In one embodiment, the light sources 30 are LED strips located along the two sides of the replaceable lid 20. In other embodiments, the location, type and number of light sources can vary depending on the application and the desired use of the replaceable lid. It is also understood that the power sources can be housed in a light source unit and be removable and/or movable. Alternatively, the power source can be in electrical connection with the light source and not housed within a light source unit.

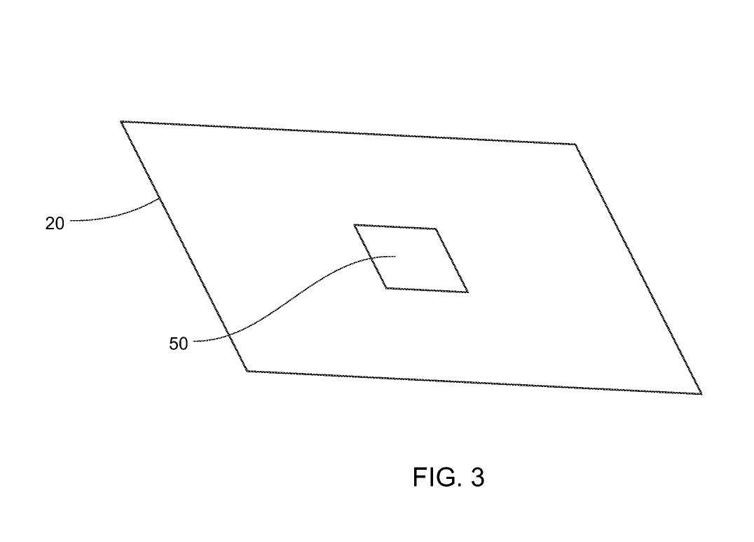

FIG. 3 represents a top view of an embodiment of the lighting system of the present invention. More specifically, FIG. 3 shows a top view of an embodiment of the present invention of a replaceable lid that contains a solar cell 50 for use in recharging the power source.

One embodiment of the lighting system of the present invention provides a replaceable lid, or lighting system, which can be used to illuminate an area external to the thermally-insulted container. This can be useful in situations when the user is travelling, including, but not limited to, when the user is camping, sailing, driving and the like at night. This can be useful in situations including, but not limited to, at times when access to electricity is limited as in during or following a storm, or during or following a natural disaster.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What claimed:

1. A lighting system for use with a thermally-insulated container, comprising:
a light source, wherein the light source comprises at least one LED;
a power source, wherein the power source comprises at least one battery and is in electrical connection with the light source; and
a replaceable lid, wherein the lid is formed to fit onto a thermally-insulated container and is configured to accept the light source and the power source.

2. The lighting system for use with a thermally-insulated container of claim 1, wherein the lid further comprises a layer configured to cover the light source and power source thereby preventing exposure of the light source and power source to moisture.

3. The lighting system for use with a thermally-insulated container of claim 2, wherein the layer is colored.

4. The lighting system for use with a thermally-insulated container of claim 2, wherein the layer is transparent.

5. The lighting system for use with a thermally-insulated container of claim 1, wherein the at least one LED is colored.

6. The lighting system for use with a thermally-insulated container of claim 1, wherein the at least one LED is configured to produce modulated light.

7. The lighting system for use with a thermally-insulated container of claim 6, wherein the light source is used to signal for help.

8. The lighting system for use with a thermally-insulated container of claim 1, wherein the at least one LED comprises a strip of LEDs.

9. The lighting system for use with a thermally-insulated container of claim 1, wherein the at least one battery is rechargeable.

10. The lighting system for use with a thermally-insulated container of claim 9, further comprising at least one solar cell for recharging the at least one battery.

11. The lighting system for use with a thermally-insulated container of claim 1, wherein the light source and power source are reversibly attached to the lid and are capable of acting as a stand-alone light.

12. The lighting system for use with a thermally-insulated container of claim 1, wherein the thermally-insulated container is integrally formed in a land vehicle.

13. The lighting system for use with a thermally-insulated container of claim 1, wherein the thermally-insulated container is integrally formed in a water craft.
